(19) United States
(12) Patent Application Publication
(10) Pub. No.: US 2026/0203691 A1
(43) Pub. Date: Jul. 16, 2026

(54) GUIDED WORKFLOW FOR PLANOGRAMS

(71) Applicant: TARGET BRANDS, INC., Minneapolis, MN (US)

(72) Inventors: Shadow Rae ARENS, Minneapolis, MN (US); Merrick Martin MAYER, Minneapolis, MN (US); Manu PHILIP, Minneapolis, MN (US); Jamie Lois Marschel UNGER, Minneapolis, MN (US)

(21) Appl. No.: 19/020,924

(22) Filed: Jan. 14, 2025

(51) Int. Cl. G06Q 10/0631; G06F 3/04842

(52) U.S. Cl. CPC G06Q 10/06316; G06F 3/04842

(57) ABSTRACT

An automated workflow of a planogram guides a worker or workers in the construction of a merchandise display. The guided workflow breaks the planogram into distinct guided phases and tasks. A task may be further broken down into actions and/or sub-tasks. The worker(s) executing the guided workflow is presented with a series of user interfaces that guide the worker(s) through the phases, the tasks, and any sub-tasks.

### BACKGROUND

Planograms are used in various retail businesses and show where and how retail products and associated materials are to be placed on merchandise displays, such as retail shelves. A planogram may be considered a blueprint for where to set shelves or any fixture that the retail products are placed on, where and how to set the retail products, and where to place any promotional signs, labels, and in-store marketing (ISM) materials. One example of an ISM material is a sign that identifies the retail product for sale, and one example of a label is the price label. Many retail businesses construct hundreds if not thousands of merchandise displays every year. The construction of a merchandise display can include many items, many operations, and be quite time consuming, which can cost a retail business a significant amount of money.

### SUMMARY

In one aspect, a computer-implemented method for executing a planogram includes transmitting a first user interface to a computing device. The first user interface is configured to present a selectable task associated with the planogram and a selectable input element to be selected when the task is completed. A selection of the task is received from the computing device. A start timestamp is received, and a second user interface is transmitted to the computing device based receiving the selection of the task. The second user interface is configured to present information associated with the task and a selectable input element to be selected when the task is completed, the information comprising a list of one or more actions to be performed. A selection of the selectable input element indicating the task is completed is received from the computing device. A stop timestamp is received in response to receiving the selection of the selectable input element. Based on the start and the stop timestamps, an amount of time needed to complete the task is determined. A notification indicating the task is completed and the amount of time needed to complete the task is transmitted to the computing device or to another computing device.

In another aspect, a system includes a processor and a memory. The memory stores instructions, that when executed by the processor, cause operations to be performed. The operations include transmitting a first user interface to a computing device. The first user interface is configured to present a plurality of selectable tasks associated with a new merchandise display to be constructed and first selectable input elements to be selected when each task is completed, where the plurality of selectable tasks is included in a planogram. For each task in the list of selectable tasks, a selection of a task is received; a start timestamp is received in response to receiving the selection of the task; a second user interface is transmitted to the computing device, where the second user interface is configured to present a sub-task associated with the task and the sub-task is included in the planogram; a third user interface is transmitted to the computing device based on receiving a selection of the sub-task, where the third user interface is configured to present information associated with the sub-task and a second selectable input element to be selected when the sub-task is completed; a selection of the second selectable input element indicating the sub-task is completed is received from the computing device; a selection of the first selectable input element indicating the task is completed is received from the computing device; a stop timestamp is received in response to receiving the selection of the first selectable input element; and based on the start and the stop timestamps, an amount of time needed to complete the task is determined. A notification is transmitted to the computing device, where the notification indicates the plurality of tasks is completed and the amount of time needed to complete each task.

In yet another aspect, a computer-implemented method of executing a guided workflow to construct a merchandise display associated with a planogram includes transmitting a first user interface to a first computing device. The first user interface is configured to present a selectable task associated with the merchandise display and a progress indicator for the selectable task. A second user interface is transmitted to the first computing device in response to receiving a selection of the task. The second user interface is configured to present a plurality of sub-tasks associated with the task. A start timestamp is received based on receiving the selection of the task. For each sub-task in the plurality of sub-tasks: a third user interface is transmitted to the first computing device based on receiving a selection of a sub-task, where the third user interface is configured to present information associated with the sub-task and a selectable input element to be selected when the sub-task is completed; a selection of the selectable input element indicating the sub-task is completed is received from the first computing device; and the progress indicator associated with the task is updated based on the completion of the sub-task. A stop timestamp is received based on the completion of the plurality of sub-tasks. Based on the start and the stop timestamps, an amount of time needed to complete the task is determined. A notification is transmitted to a second computing device indicating the task is completed and the amount of time needed to complete the task.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the figures.

FIG. 1 illustrates a block diagram of an example system to execute a guided workflow according to an embodiment of the disclosure;

FIG. 2 illustrates a flowchart of a method of executing a guided workflow to construct a merchandise display associated with a planogram according to an embodiment of the disclosure;

FIGS. 3A-3B illustrate a flowchart of a method of executing a guided workflow to construct a merchandise display associated with a planogram according to an embodiment of the disclosure;

FIG. 4 illustrates a table showing example phases, example tasks, and example sub-tasks of a guided workflow according to an embodiment of the disclosure;

FIG. 5 illustrates an example user interface for beginning a guided workflow according to an embodiment of the disclosure;

FIG. 6 illustrates an example user interface for confirming or changing a location in a guided workflow according to an embodiment of the disclosure;

FIG. 7 illustrates an example user interface to change a location associated with a planogram in a guided workflow according to an embodiment of the disclosure;

FIG. 8 illustrates an example user interface to change the location associated with a planogram in a guided workflow according to an embodiment of the disclosure;

FIG. 9 illustrates an example user interface in a guided workflow according to an embodiment of the disclosure;

FIG. 10 illustrates an example user interface displaying a start screen in a guided workflow according to an embodiment of the disclosure;

FIG. 11 illustrates an example user interface associated with a sub-task in a guided workflow according to an embodiment of the disclosure;

FIG. 12 illustrates an example user interface associated with a sub-task in a guided workflow according to an embodiment of the disclosure;

FIG. 13 illustrates an example user interface associated with a sub-task in a guided workflow according to an embodiment of the disclosure;

FIG. 14 illustrates an example user interface associated with a sub-task in a guided workflow according to an embodiment of the disclosure;

FIG. 15 illustrates the example user interface shown in FIG. 10 displaying the start screen after a phase is completed according to an embodiment of the disclosure;

FIG. 16 illustrates an example user interface for a task in a guided workflow according to an embodiment of the disclosure;

FIG. 17 illustrates an example user interface that displays information on a planogram in a guided workflow according to an embodiment of the disclosure;

FIG. 18 illustrates an example user interface that displays information on a planogram in a guided workflow according to an embodiment of the disclosure;

FIG. 19 illustrates an example user interface that displays information on a planogram in a guided workflow according to an embodiment of the disclosure;

FIG. 20 illustrates an example user interface in a guided workflow according to an embodiment of the disclosure;

FIG. 21 illustrates an example user interface displaying information on multiple planograms according to an embodiment of the disclosure; and

FIG. 22 illustrates a block diagram of an example computing system for implementing various embodiments in the examples described herein.

### DETAILED DESCRIPTION

Embodiments disclosed herein provide an automated workflow of a planogram to guide a worker in the construction of a merchandise display. The guided workflow breaks the planogram into distinct guided tasks that are presented to the worker via a series of user interfaces. A user interface can be hierarchical in that a task is further broken down into “actions” and/or “sub-tasks”. For example, a list of all of the tasks to be completed can be displayed in one user interface. In one embodiment, “actions” are projects or work the worker is to complete but the progress of the actions may not be tracked individually. “Sub-tasks” are projects the worker is to complete but the progress of the sub-tasks can be tracked individually. Other embodiments may track the progress of actions and not sub-tasks individually or both actions and sub-tasks individually.

When a particular task is selected, a list of sub-tasks for the selected task may be displayed in another user interface. Progress indicators can be displayed for each task and/or for each sub-task. For example, the progress indicators for the tasks and/or the sub-tasks can be in a Not Started state, a Ready state, a Started state, or a Completed state. A user interface can include additional information on a task or sub-task, such as a description of the task/sub-task, a list of items needed for the task/sub-task, a number of items to be used, a list of marketing documents (e.g., signs, labels, etc.), an image presenting at least a portion of the merchandise display when completed, dimensions of at least a portion of the merchandising display, intended sales floor locations and any deviations from an intended sales floor location, item and capacity overrides, and/or other information. An image can be an image, a drawing, a graphic, an illustration, or other type of representation.

Start and stop times for the tasks, sub-tasks, and/or actions may be captured via timestamps, enabling the amounts of time for each task/sub-task to be determined. A worker can provide notes during or after the construction of the merchandise display. The notes can provide feedback on why the location of the merchandise display was changed, issues encountered during the construction of the merchandise display, suggestions for future merchandise displays, and any other topics. Reports may be generated based on the timestamps and/or the notes and transmitted to a computing device.

Embodiments enable the status of the construction of a planogram to be updated and monitored in real-time. Various individuals, such as supervisors, managers, department heads, and other works can view the real-time status of the construction of the planogram. Additionally, any notes, feedback, or suggestions may be viewed in real time during the construction of the planogram.

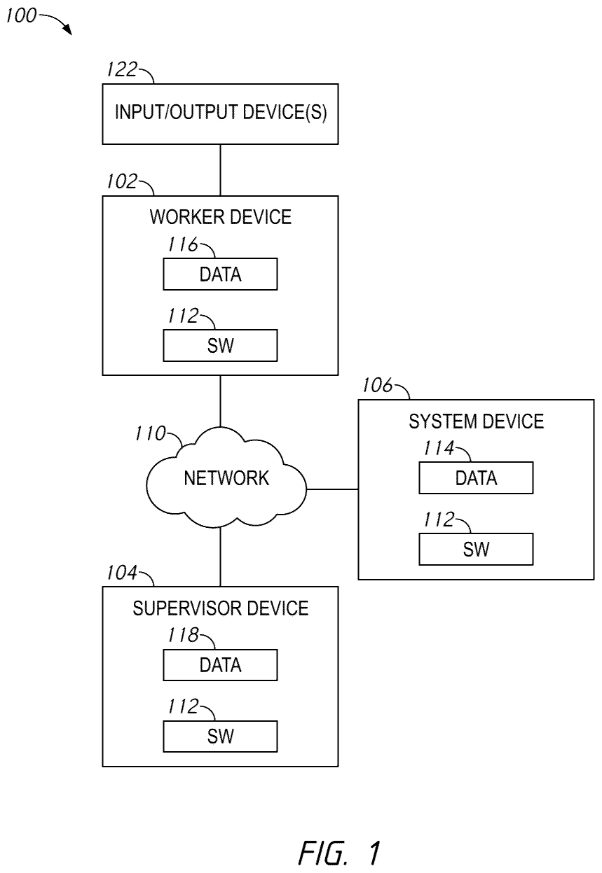

FIG. 1 illustrates a block diagram of an example system 100 to execute a guided workflow according to an embodiment of the disclosure. The system 100 may include a worker device 102, a supervisor device 104, and a system device 106. The worker device 102 can be used by one or more workers at the same retail location or at different retail locations. The supervisor device 104 may be used by a supervisor, manager, department head, owner, and/or other person that oversees and/or manages the retail business or a department in the retail business. For example, the department can be beauty, clothing, electronics, and the like. Examples of a worker device 102 and a supervisor device 104 include, but are not limited to, smart phones, tablets, laptops, wearable devices, or other computing devices.

The system device 106 may be a device at the retail business, at a headquarters of the retail business, and/or at an offsite location. Examples of the system device 106 include, but are not limited to, a smart phone, a tablet, a laptop, a server, a desktop computer, a mainframe computer, cloud-based computing, a distributed computing system, or another computing system.

The worker device 102, the supervisor device 104, and the system device 106 may be in communication with each other through a network 110. The network 110 can be configured as one or more systems and protocols for communications between computing devices. Example network systems include, but are not limited to, a wide area network, a local area network, an enterprise private network, the Internet, a cloud-based network, or combinations thereof.

Software 112 and data 114 on the system device 106 may be used to provide guided workflows to the worker device 102 and the supervisor device 104. The worker device 102 includes the software 112 and data 116, where the data 116 is associated with one or more guided workflows. The supervisor device 104 includes the software 112 and data 118. The data 118 may be the same as data 114, the data 116, and/or other data that is associated with guided workflows. As discussed previously, the guided workflows are used to construct merchandise displays that are associated with planograms in the retail business(es).

The worker device 102 is connected to one or more input/output devices 122. The input/output device 122 may be a printer, a scanner, a camera, a microphone, speakers, a keyboard, and other input/output devices. The input/output device 122 may be used during the execution of a guided workflow. Although FIG. 1 depicts only one worker device 102, one supervisor device 104, one system device 106, and one input/output device 122, other embodiments can include any number of worker devices 102, supervisor devices 104, system devices 106, and/or input/output devices 122.

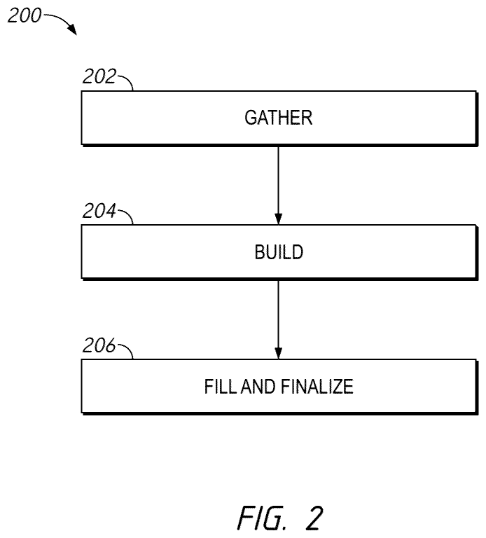

FIG. 2 illustrates a flowchart of a method 200 of executing a guided workflow to construct a merchandise display associated with a planogram according to an embodiment of the disclosure. A guided workflow may have multiple phases. In the illustrated embodiment, the guided workflow has three phases: a gather phase 202, a build phase 204, and a fill and finalize phase 206. Other embodiments may have fewer or more phases. For example, a guided workflow can omit the gather phase in some embodiments. As will be described in more detail later, each phase can have one or more tasks, with some or all of the tasks having actions and/or sub-tasks.

The gather phase 202 may have one or more tasks and sub-tasks that are associated with preparing and collecting the materials that will be used to construct the merchandise display. The build phase 204 can have one or more tasks and sub-tasks that are associated with constructing the merchandise display. The fill and finalize phase 206 may have one or more tasks and sub-tasks that are associated with placing merchandise on the constructed merchandise display and performing follow up procedures.

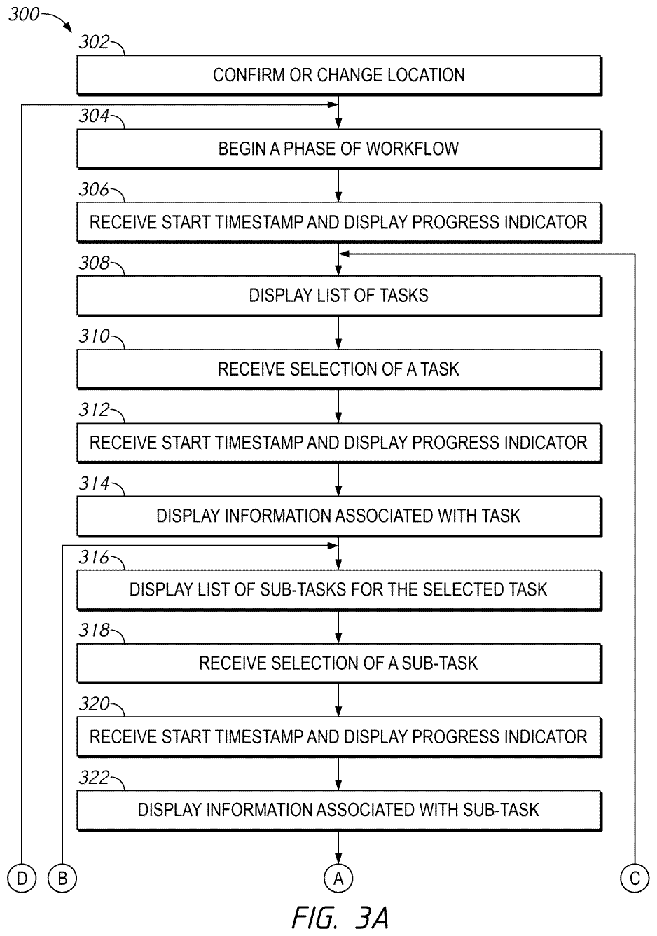

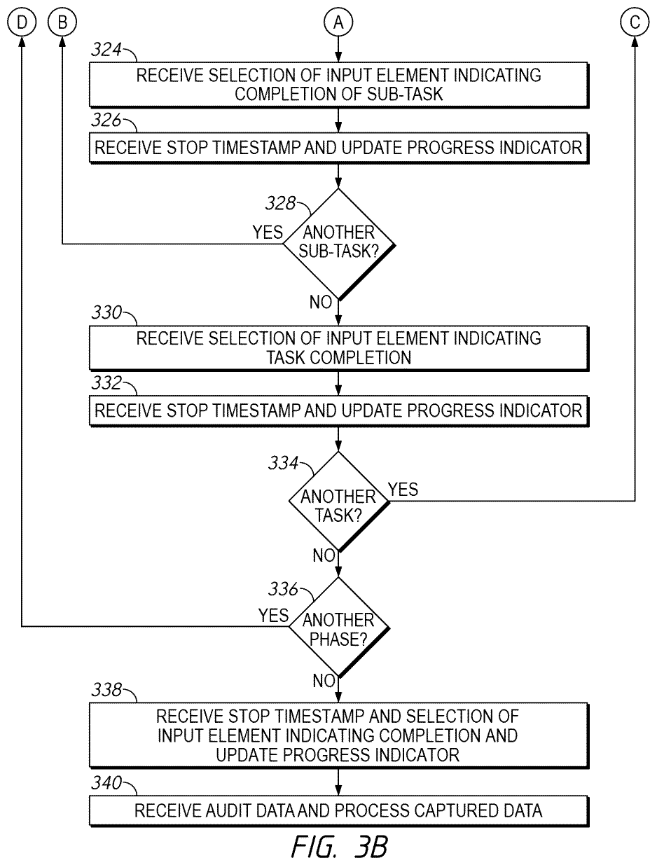

FIGS. 3A-3B illustrate a method 300 of executing a guided workflow to construct a merchandise display associated with a planogram according to an embodiment of the disclosure. The method 300 is described in conjunction with the execution of a single guided workflow. However, the method 300 may be performed for multiple guided workflows simultaneously, concurrently, or at select times.

At block 302, a location of a merchandise display associated with the planogram within a retail business is confirmed or changed. The location of the merchandise display may be changed for a variety of reasons. For example, a pole may be at or adjacent the original location that would restrict access to the merchandise on the merchandise display. Alternatively, the entire merchandise display, once constructed, may not fit completely in the original location. A worker can change the location of the merchandise display to a new location and provide feedback as to why the location was changed.

At block 304, a phase of the guided workflow begins. In one embodiment, the phase can be one of the phases shown in FIG. 2. A worker can select an input element in a user interface to indicate the start of the phase.

At block 306, a start timestamp is captured in response to the selection of the input element. The start timestamp can be used to determine an amount of time needed to complete the phase. In some embodiments, when the phase that is started at block 304 is the first phase of the guided workflow, the start timestamp may also be used to determine an amount of time needed to complete the guided workflow, which corresponds to the amount of time needed to complete the construction and place merchandise on the merchandise display. Additionally, at block 306, one or more progress indicators may be set or modified based on starting the phase. The progress indicator(s) can be displayed in a user interface and used to monitor the progress of the work performed for the phase.

At block 308, a list of tasks to be performed in that phase is displayed. The list of tasks can be displayed in a user interface. At block 310, a selection of a task in the list of tasks is received. The task may be selected using any suitable technique, such as by selecting an input element displayed in the user interface or by selecting (e.g., tapping) on the task in the user interface.

At block 312, a start timestamp is captured in response to the selection of the task. The start timestamp can be used to determine an amount of time needed to complete the task. Additionally, at block 312, one or more progress indicators may be set or modified based on the selection of the task. The progress indicator(s) can be displayed in a user interface and used to monitor the progress of the work on the selected task.

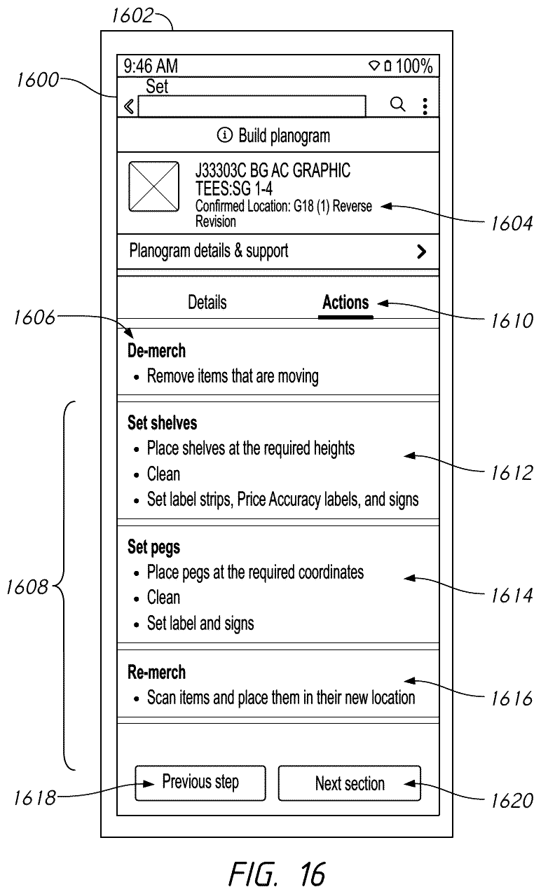

At block 314, information associated with the task can be displayed. A task can include one or more actions that are to be performed. The information can be a list of the one or more actions to be performed, a description of each action to be performed, one or more images associated with the task and/or an action, and other information. Non-limiting nonexclusive examples of information that is associated with a task is shown and described in more detail in conjunction with FIGS. 16-20.

In some embodiments, the actions that are associated with a task may be configured as sub-tasks. As described earlier, each sub-task may be tracked individually (e.g., start and stop times). A progress indicator for the task can reflect the number of sub-tasks that have been completed. For example, if a task has two sub-tasks, the progress indicator may indicate 50% of the task is complete when the first sub-task is completed and indicate 100% of the task is complete when the second sub-task is completed.

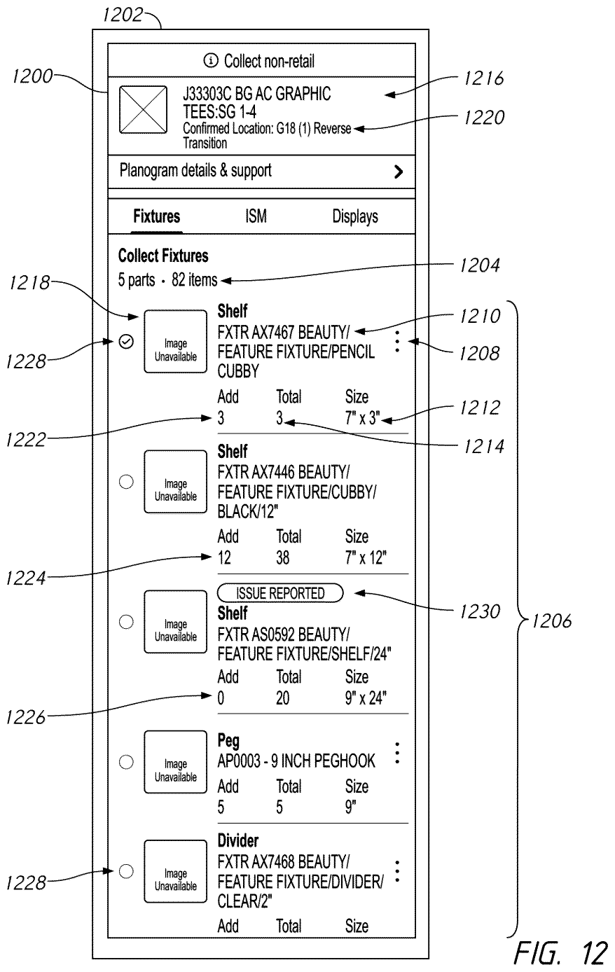

At block 316, a list of sub-tasks to be performed for that task may be displayed. The list of sub-tasks can be displayed in a user interface. Non-limiting nonexclusive examples of user interfaces displaying sub-tasks are shown and described in conjunction with FIGS. 12-14.

At block 318, a selection of a sub-task in the list of sub-tasks is received. The sub-task may be selected using any suitable technique, such as by selecting an input element displayed in the user interface or by selecting (e.g., tapping) the sub-task in the user interface.

At block 320, a start timestamp is captured in response to the selection of the sub-task. The start timestamp can be used to determine an amount of time needed to complete the sub-task. Additionally, at block 320, one or more progress indicators may be set or modified based on the selection of the sub-task. The progress indicator(s) can be displayed in a user interface and used to monitor the progress of the work on the selected sub-task and on the task. For example, if a sub-task has two actions to be performed, a progress indicator for the sub-task can be adjusted after the first action is performed (indicating sub-task 50% complete) and then again after the second action is performed (indicating sub-task 100% complete).

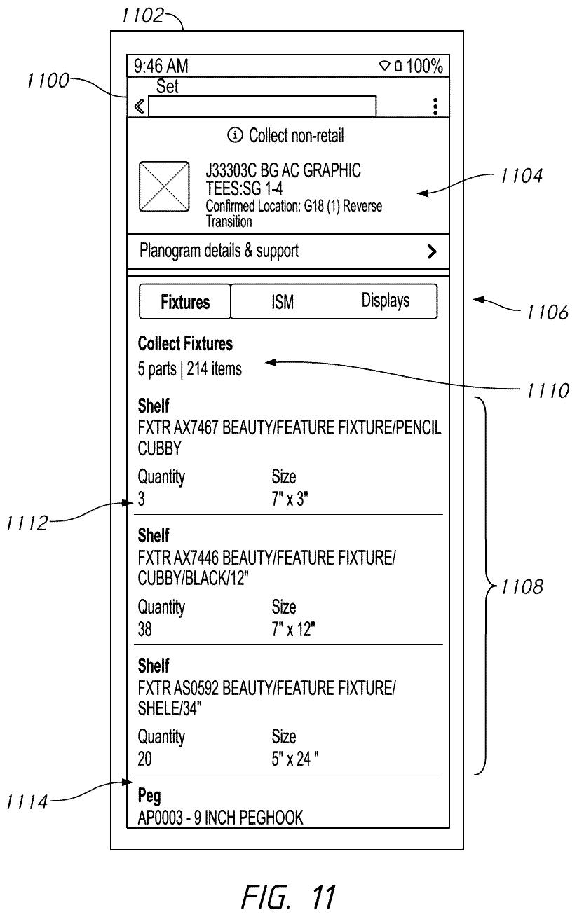

At block 322, information associated with the sub-task can be displayed. A sub-task can include one or more actions that are to be performed. The information can be a list of the one or more actions to be performed, a description of each action to be performed, one or more images associated with the sub-task and/or an action, and other information. Non-limiting nonexclusive examples of information that is associated with a sub-task is shown and described in conjunction with FIGS. 11-14.

One action that may be performed for a task and/or a sub-task is the collection of materials to be used in the construction of the planogram. In some embodiments, a computing device (e.g., the system device 106 of FIG. 1) can adjust the number of materials to be collected based on the type and number of materials that are in an existing planogram at the same location where the new planogram is to be constructed. For example, if a new planogram requires ten shelves, and an existing planogram at the same location has five shelves, the number of shelves to be collected by the worker can be reduced to five shelves (for a total of ten shelves). A non-limiting non-exclusive example of this type of adjustment is shown and described in more detail in conjunction with FIG. 12.

At block 324, a selection of an input element is received, where the input element indicates the work on the sub-task is completed. In some embodiments, a confirmation notification may be sent based on the completion of the sub-task. For example, an email or text message can be transmitted to a computing device (e.g., worker device 102 and/or the supervisor device 104 of FIG. 1) regarding the completion of the sub-task.

At block 326, a stop timestamp is captured in response to the selection of the input element that is associated with completion of the sub-task. The stop timestamp, along with the start timestamp captured at block 320, can be used to determine an amount of time needed to complete the sub-task.

At block 328, a determination is made as to whether there is another sub-task to be completed for the current task. If a determination is made that there is another sub-task, the method returns to block 316. Blocks 316, 318, 320, 322, 324, 326, and 328 repeat until all of the sub-tasks associated with the current task are complete.

When a determination is made at block 328 that all sub-tasks are complete (i.e., there is no additional sub-task), the method passes to block 330 where a selection of an input element is received. The selection of the input element indicates work on the task is complete. In some embodiments, a confirmation notification may be sent based on the completion of the task. For example, an email or text message can be transmitted to a computing device (e.g., worker device 102 and/or supervisor device 104 of FIG. 1) regarding the completion of the task.

At block 332, a stop timestamp is captured in response to the selection of the input element that is associated with the completion of the task. The stop timestamp, along with the start timestamp captured at block 312, can be used to determine an amount of time needed to complete the task. Additionally, at block 332, one or more progress indicators may be set or modified based on the completion of the task.

At block 334, a determination is made as to whether there is another task to be performed in the current phase. If a determination is made that there is another task, the method returns to block 308. Blocks 308, 310, 312, 314, 316, 318, 320, 322, 324, 326, 328, 330, 332, and 334 repeat until all of the tasks associated with the current phase are complete.

When a determination is made at block 334 that all tasks are complete (i.e., there is no additional task to be performed), the method passes to block 336 where a determination is made as to whether there is another phase to be completed. If a determination is made that there is another phase, the method returns to block 304. Blocks 304, 306, 308, 310, 312, 314, 316, 318, 320, 322, 324, 326, 328, 330, 332, 334, and 336 repeat until all of the phases associated with the planogram are complete. When a determination is made at block 336 that all phases are complete (i.e., there are no additional phases), the method passes to block 338 where a selection of an input element is received, the input element indicating work on the planogram is complete. Additionally, at block 338, a stop timestamp may be received, and a progress indicator updated to indicate the work is complete. In some embodiments, a confirmation notification may be sent based on the completion of the phase. For example, an email or text message can be transmitted to a computing device (e.g., worker device 102 and/or supervisor device 104 of FIG. 1) regarding the completion of the phase.

At block 340, audit data may be received and/or the captured data can be processed. In one embodiment, the audit data includes information and/or comments (“notes”) that are received from the worker(s) that constructed the merchandise display. For example, the audit data may provide notes on any issues the worker experienced during the construction of the merchandise display or any changes the worker made to the planogram and/or the merchandise display. The captured data may include processing one or more start timestamps and stop timestamps to determine the amount of time needed to complete one or more events (e.g., a task, sub-task, a phase, and/or the planogram). One or more reports may be generated by a computing system (e.g., the system device 106 of FIG. 1) based on the audit data and/or the captured data. For example, a report may provide a comparison on the expected amount of time to complete a planogram, and the actual amount of time needed to complete the planogram. The amount of time needed to complete one or more tasks and/or sub-tasks can be listed. The notes received from the worker(s) can be included in a report. The report(s) can be transmitted to one or more computing devices (e.g., the supervisor device 104 and/or the system device 106 of FIG. 1). In some embodiments, the amount of time(s) to complete an event across multiple retail locations can be processed together. For example, the amount of time needed to complete the planogram may be normalized across the multiple retail locations.

In some embodiments, a merchandise display that is associated with a planogram can be constructed by multiple workers. Some or all of the phases, tasks, and/or sub-tasks may be completed by two or more workers. In such embodiments, one or more reports can provide information on the events (e.g., phases, tasks, and/or sub-tasks) by worker. For example, if two workers complete a task (regardless of whether the two workers work on the same sub-task(s) or not), a report can provide information on the worker (e.g., the name and/or the employee number) and/or the amount of time spent by each worker on the task. In some instances, where a task and/or a sub-task is completed separately by multiple workers, the computing system (e.g., the system device 106 of FIG. 1) can capture all start and stop timestamps and include all amounts of time, one amount of time (e.g., the longest or the shortest), and/or a difference in the amounts of time that were needed to complete the merchandise display. The report can specify the amount of time needed by each worker or may provide a computed amount of time (e.g., an average, an aggregate, etc.). Other data, such as information or notes provided by the worker(s), can be included in a report in some embodiments.

Although FIGS. 3A-3E depict certain operations performed in a particular order, other embodiments are not limited to this configuration. For example, blocks 316, 318, 320, 322, 324, 326, and 328 may be omitted in embodiments where a selected task does not have any associated sub-tasks. Additionally or alternatively, one or more progress indicators may not be set or updated when a progress indicator is not shown (e.g., one or more of blocks 306, 312, 320, 326, 332, 338).

In some embodiments, a merchandise display that is associated with a planogram may be constructed at multiple sales floor locations in one or more retail businesses. In such embodiments, a unique task can be created for each location. Each unique task may be included in the list of tasks that are displayed at block 308. A particular list of tasks that includes a unique task can be displayed when the guided workflow for that location is executed.

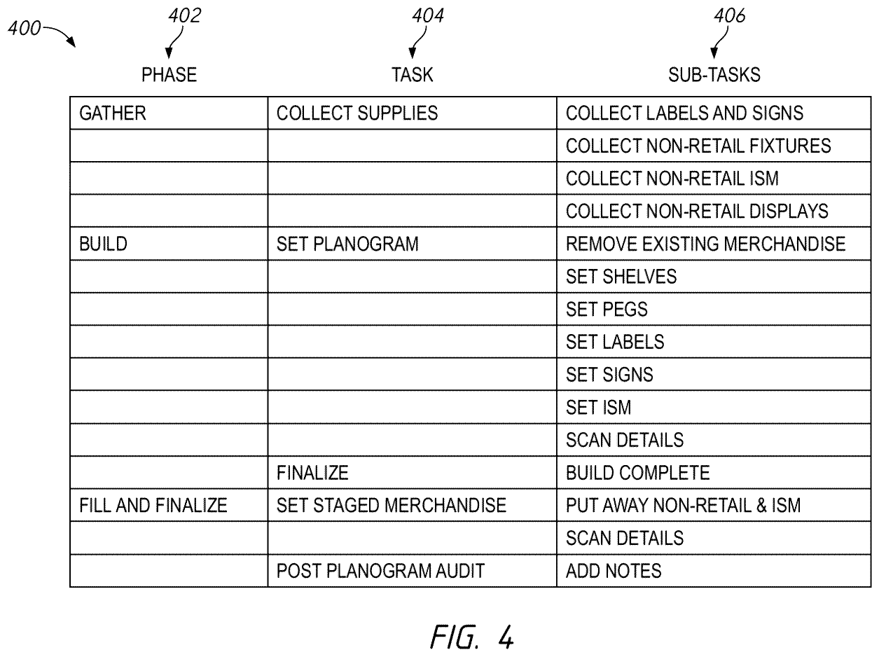

FIG. 4 illustrates a table 400 showing example phases 402, example tasks 404, and example sub-tasks 406 of a guided workflow according to an embodiment of the disclosure. The phases 402 include a gather phase, a build phase, and a fill and finalize phase. Each phase 402 includes at least one task 404. For example, the gather phase includes a collect supplies task. The collect supplies task enables the items to be used in the merchandise display to be collected and grouped together in storage (e.g., a backroom or a warehouse). In some embodiments, a notification may be transmitted to a computing device (e.g., the worker device 102 of FIG. 1) indicating the items to be used in the merchandise display have been received at the retail business.

The build phase includes a set planogram task and a finalize task. The fill and finalize phase includes a set staged merchandise task and a post planogram audit task.

In the illustrated embodiment, each task 404 has one or more sub-tasks 406. The collect supplies task in the gather phase includes the sub-tasks 406 of collecting labels and signs, collecting non-retail fixtures, collecting non-retail ISM, and collecting non-retail displays. The set planogram task in the build phase includes the sub-tasks 406 of removing existing merchandise, setting shelves, setting pegs, setting labels, setting signs, setting ISM, and scanning details. The finalize task in the build phase includes the sub-tasks 406 of confirming the build of the planogram is complete. The set staged merchandise task in the fill and finalize phase includes the sub-tasks 406 of putting away the non-retail materials and the ISM and scanning details. The post planogram audit task in the fill and finalize phase includes the sub-task 406 of adding notes.

Each of the phases, tasks, and sub-tasks are included in a guided workflow in one embodiment. A worker executing the guided workflow is presented with a series of user interfaces that guide the worker through the phases, tasks and sub-tasks in an orderly process. For each phase, a user interface may be provided for each task. For one or more tasks, a user interface can be displayed for one or more sub-tasks. The user interfaces guide the worker through the process of constructing the merchandise display associated with the planogram while capturing information associated with the construction of the merchandise display.

The phases, tasks, and sub-tasks shown in FIG. 4 are only examples, and other embodiments can include fewer, different, or additional phases, tasks, and/or sub-tasks. For example, the phases 402 may include only the build and fill and finalize phases. Additionally or alternatively, the sub-task of setting signs can be omitted from the set planogram task when a planogram does not use signs.

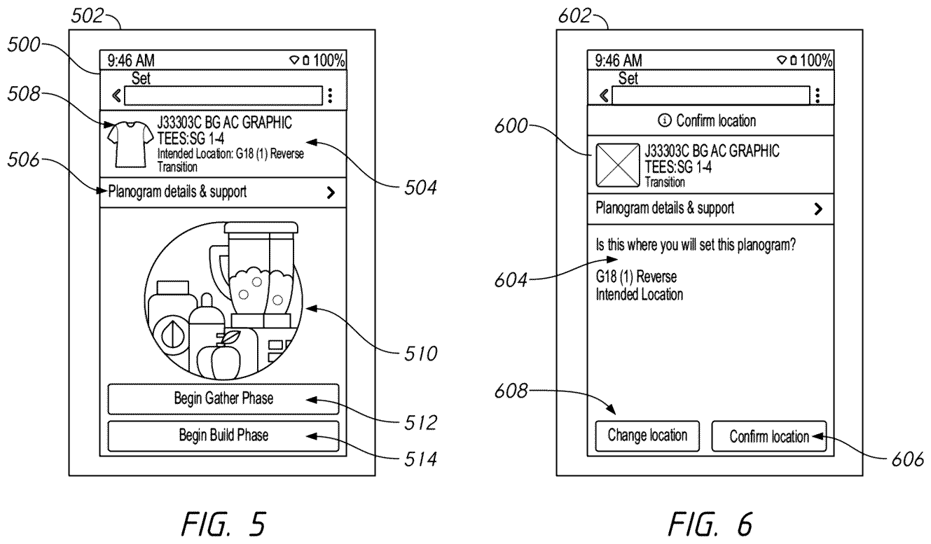

FIG. 5 illustrates an example user interface 500 for beginning a guided workflow according to an embodiment of the disclosure. The user interface 500 is shown as displayed on a display screen 502 of a display device. The user interface 500 includes information 504 on the planogram. In the illustrated embodiment, the information 504 includes an intended location within the retail business where the merchandise display that is associated with the planogram is to be constructed, but other embodiments can include additional or different information.

The user interface 500 includes an input element 506 that a worker can select to display additional details on the planogram. An image 508 of the merchandise to be displayed in the planogram can be displayed in the user interface 500. Additionally, an image 510 may be displayed in the user interface 500. The image 510 may be any type of image. For example, in one embodiment, the image 510 can be an image of the planogram as constructed to enable the worker to see the final merchandise display. In another embodiment, the image 510 may be a map of the retail business showing the location of the merchandise display in the retail business. In other embodiments, other information may be displayed instead of the image 510.

The user interface 500 includes an input element 512 that a worker can select to indicate the worker is beginning the gather phase. In some embodiments, the worker may select the input element 512 to specify a location on a sales floor where the merchandise display associated with the planogram will be constructed. This allows the location to be provided (e.g., printed) on the shipments of merchandise received by the retail business. The user interface 500 includes an input element 514 that a worker can select to indicate the worker is beginning the guided workflow (e.g., begin the build phase). As described earlier in conjunction with FIGS. 3A-3B, a start timestamp may be captured and/or a progress indicator updated based on the selection of the input element 514. For example, an expected amount of time to complete the construction of the merchandise display may be displayed.

FIG. 6 illustrates an example user interface 600 for confirming or changing a location in a guided workflow according to an embodiment of the disclosure. The user interface 600 is shown as displayed on a display screen 602 of a display device. The intended or original location 604 is displayed in the user interface 600. The worker can select the input element 606 to confirm the original location is correct, or the worker may select the input element 608 to indicate the location associated with the planogram is to be changed.

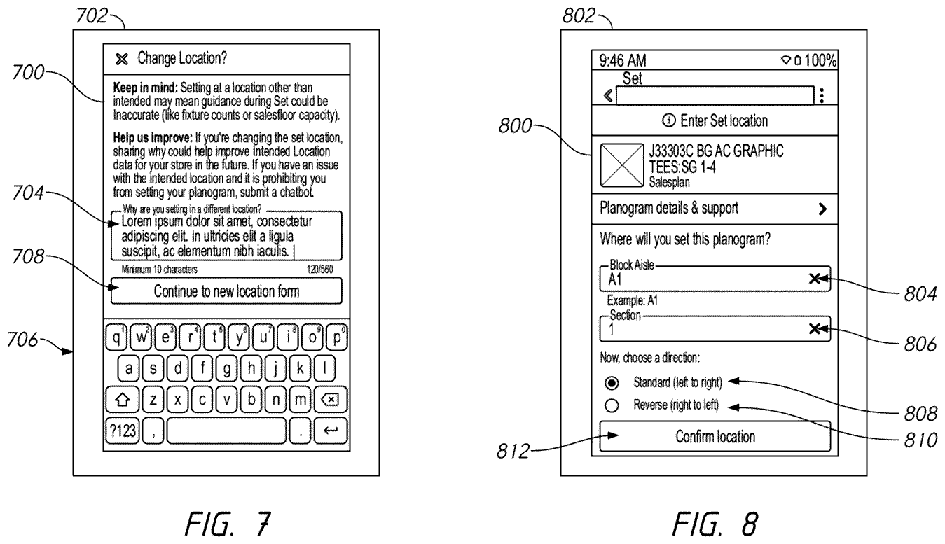

FIG. 7 illustrates an example user interface 700 to change the location associated with a planogram in a guided workflow according to an embodiment of the disclosure. The user interface 700 is shown as displayed on a display screen 702 of a display device. The user interface 700 may be displayed in response to the worker selecting the input element 608 in the user interface 600 shown in FIG. 6. The user interface 700 includes an input element 704, such as a text box, to enable the worker to enter a reason for changing the location. The reason for changing the location may be saved for future planograms and/or that location. The reason can assist the retail business in determining acceptable or optimal locations within the retail business for future planograms.

The worker can enter the reason in the input element 704 using a virtual keyboard 706. The worker may select the input element 708 to cause a new location form to be displayed. The worker can provide more information on the new location using the new location form.

FIG. 8 illustrates an example user interface 800 to change the location associated with a planogram in a guided workflow according to an embodiment of the disclosure. The user interface 800 is shown as displayed on a display screen 802 of a display device. The user interface 800 may be displayed in response to the worker selecting the input element 708 in the user interface 700 shown in FIG. 7.

The user interface 800 displays input elements 804, 806 that receive location data for the new location of the planogram. In the illustrated embodiment, the location data includes an aisle identifier (e.g., “A1”) and a section identifier (e.g., “1”). The user interface 800 may also include input elements 808, 810 to enable the worker to input a direction of the planogram (e.g., standard or reverse). Once the location data has been entered, the worker can select the input element 812 to confirm the location associated with the planogram.

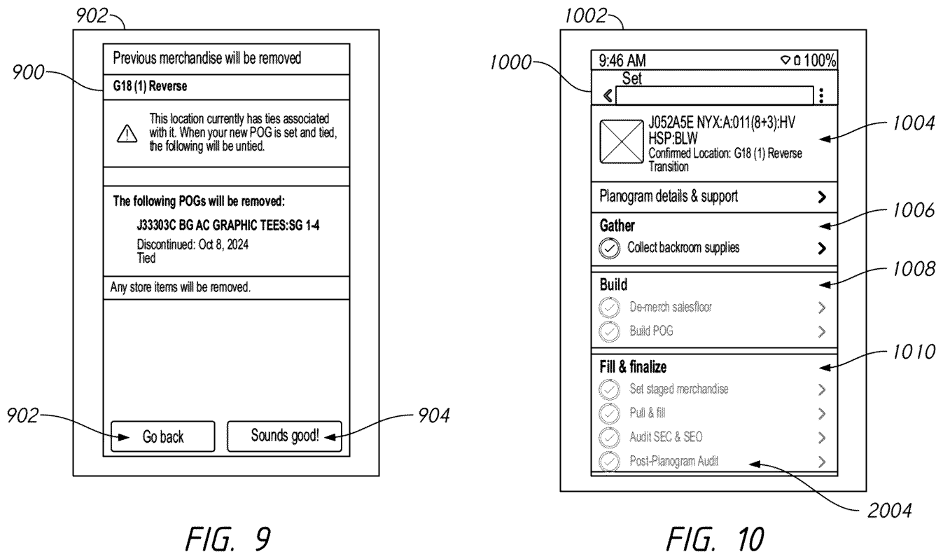

FIG. 9 illustrates an example user interface 900 in a guided workflow according to an embodiment of the disclosure. The user interface 900 is shown as displayed on a display screen 902 of a display device. The user interface 900 may be displayed in response to the worker selecting the input element 812 in the user interface 800 shown in FIG. 8.

The user interface 900 displays information on a planogram that may currently be located at the location associated with the new planogram. The user interface 900 informs the worker that if the worker proceeds with constructing the merchandise display, the planogram and/or the merchandise associated with information will no longer be associated with that location. In the illustrated embodiment, the user interface 900 informs the worker the current or existing planogram of graphic tees will be discontinued on Oct. 8, 2024. An input element 902 may be selected by the worker to go back to a previous screen (e.g., the user interface 800 in FIG. 8). For example, a worker may select the input element 902 if the current date is before the discontinue date. An input element 904 can be selected by the worker to confirm the instructions regarding the existing planogram.

FIG. 10 illustrates an example user interface 1000 displaying a start screen in a guided workflow according to an embodiment of the disclosure. The user interface 1000 is shown as displayed on a display screen 1002 of a display device. In one embodiment, the user interface 1000 may be displayed in response to the worker selecting the input element 904 in the user interface 900 shown in FIG. 9, or in response to the worker selecting the input element 606 in the user interface 600 shown in FIG. 6.

The user interface 1000 displays the phases in the planogram that is identified by the information 1004. In the illustrated embodiment, the planogram includes the gather phase, 1006, the build phase 1008, and the fill and finalize phase 1010. In one embodiment, the phases must be performed in order, although other embodiments are not limited to this configuration. As such, the gather phase 1006 will be performed first and includes the task of collecting backroom supplies. The worker selects the task (e.g., by tapping on the task) when the worker is ready to work on the task. As described earlier, a start timestamp may be captured when the worker selects the task (e.g., block 312 of FIG. 3A). Additionally, a progress indicator can be updated based on the selection of the task.

FIG. 11 illustrates an example user interface 1100 associated with a sub-task in a guided workflow according to an embodiment of the disclosure. The user interface 1100 is shown as displayed on a display screen 1102 of a display device. The user interface 1100 may be displayed in response to the worker selecting the task in the gather phase 1006 in the user interface 1000 shown in FIG. 10.

The task of collecting backroom supplies for the planogram 1104 includes three sub-tasks 1106; fixtures, ISM, and displays. The sub-tasks 1106 are configured as input elements in a segmented button, but other embodiments are not limited to this configuration. Other types of input elements may be used, such as tabs or a dropdown menu. Typically, fixtures are non-retail equipment, structures, materials (e.g., pegs, screws, bolts, etc.), and other items that are used to construct the merchandise display associated with the planogram. When selected, the Fixtures sub-task displays a list 1108 of the fixtures to be collected for the planogram 1104. As shown in FIG. 11, the list of fixtures includes various shelves and peg hooks (pegs). Other fixtures may be listed in other embodiments.

As described earlier, a start timestamp may be captured when the worker selects the Fixtures sub-task (e.g., block 320 of FIG. 3A). Additionally, a progress indicator can be updated based on the selection of the fixtures sub-task.

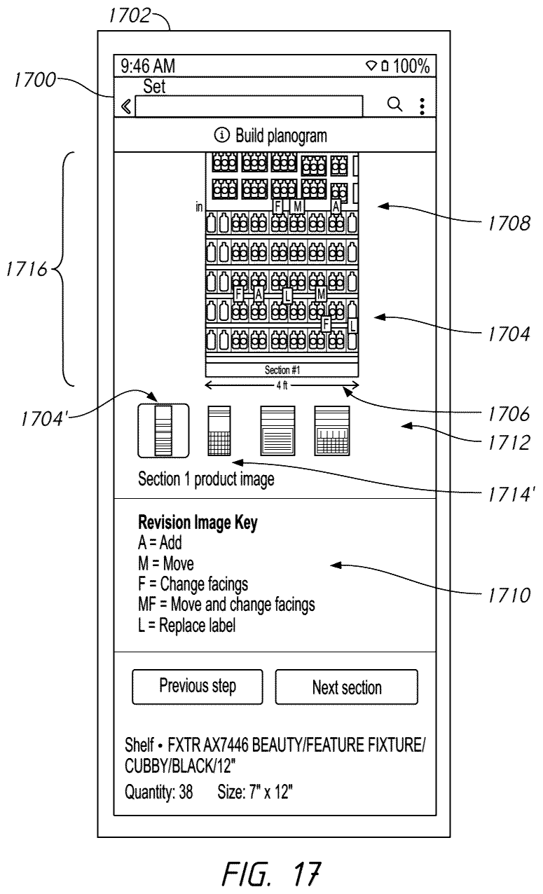

The user interface 1100 displays information 1110 on the sub-task of collecting fixtures. The information 1110 includes a number of actions associated with the sub-task (e.g., a number of fixture types to be collected or 5 parts) and a total number of fixtures to be collected (e.g., 214 items). The user interface 1100 displays additional information 1112 for each fixture to be collected. For example, for each shelf in the list of fixtures 1108, the user interface 1100 presents a quantity and a size or dimension of the fixture. For the peg fixture 1114, the part number and size of the peg is displayed. In some embodiments, one or more images of some or all of the fixtures to be collected may be displayed in the user interface 1100 (e.g., see image areas 1716, 1804, 1906 of FIGS. 17-19).

FIG. 12 illustrates an example user interface 1200 associated with a sub-task in a guided workflow according to an embodiment of the disclosure. The user interface 1200 is shown as displayed on a display screen 1202 of a display device. The user interface 1200 is an alternate user interface for the user interface 1100 (FIG. 11) and may be displayed instead of the user interface 1100. The user interface 1200 may display information 1204 on the sub-task. For example, the information 1204 can include a number of actions associated with the sub-task (e.g., a number of fixture types to be collected or 5 parts) and a total number of fixtures to be collected (e.g., 82 items).

The user interface 1200 displays a list 1206 of fixtures to be collected. The user interface 1200 can display information 1208 for each fixture to be collected. The information 1208 may include a description 1210 of the fixture, a size or a dimension 1212 of the fixture, a total number 1214 of the fixture to be used in the planogram 1216, and/or an image 1218 of the fixture. In some embodiments, a computing device (e.g., the system device 106 of FIG. 1) can adjust the number of fixtures to be collected based on the type of fixtures and the number of the fixtures that are in an existing planogram at the location 1220 for the new planogram 1216. For example, in FIG. 12, the worker is instructed to collect three additional fixtures (for a total of three fixtures) for the shelf fixture 1222. Thus, the existing planogram at the location 1220 does not include any of the shelf fixtures 1222. Alternatively, the worker is instructed to collect twelve additional fixtures (for a total of thirty-eight fixtures) for the shelf fixture 1224. A computing device (e.g., the system device 106 of FIG. 1) determined the existing planogram includes twenty-six of the shelf fixtures 1212, so the worker needs to collect the additional twelve fixtures 1224 for the new planogram 1216. Similarly, the worker is instructed to collect zero additional fixtures (for a total of twenty fixtures) for the shelf fixture 1226. The computing device (e.g., the system device 106 of FIG. 1) determined the existing planogram includes twenty shelf fixtures 1226, so the worker does not need to collect any additional fixtures 1226 for the new planogram 1216. In some embodiments, the user interface 1200 may display a notice that no fixtures are to be collected when the planogram 1216 does not need any fixtures.

The user interface 1200 includes input elements 1228 (e.g., radio buttons). In one embodiment, the worker selects (e.g., taps on) an input element 1228 when the worker has collected the fixture. A stop timestamp may be captured after all of the input elements 128 have been collected (e.g., block 324 in FIG. 3B). Additionally or alternatively, a progress indicator may be updated after each input element 1228 is selected and/or after all of the input elements 1228 are selected.

The user interface 1200 can indicate when an issue associated with a particular fixture exists, as depicted by the “issue reported” label 1230 next to the shelf fixture 1226. The issue may be related to the process of collecting the fixture. For example, the computing device (e.g., the system device 106 of FIG. 1) can determine that the fixture is unavailable (e.g., out of stock) for the new planogram 1216. The label 1230 enables the worker to address and/or document the issue before the construction of the merchandise display associated with the planogram begins or is in process.

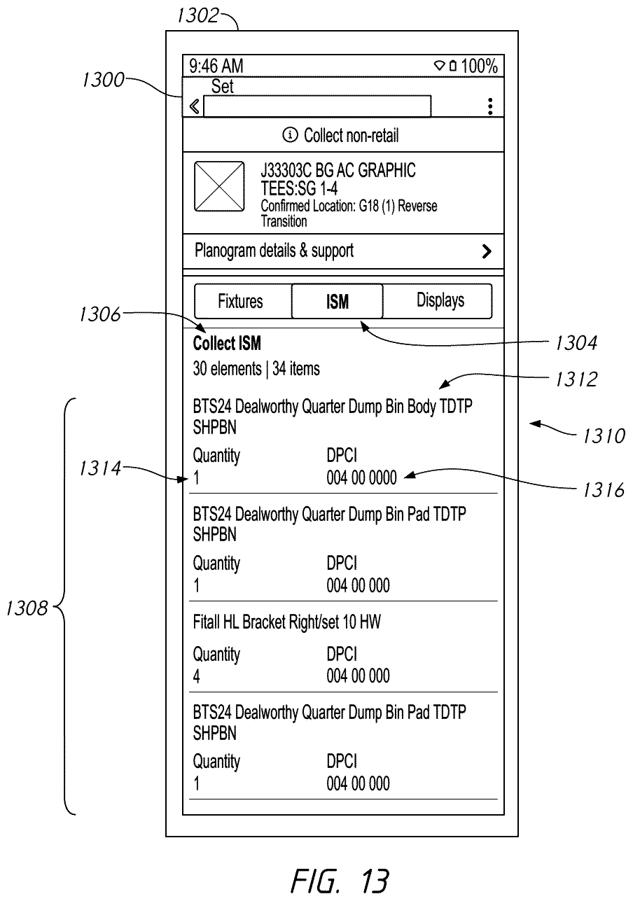

FIG. 13 illustrates an example user interface 1300 associated with a sub-task in a guided workflow according to an embodiment of the disclosure. The user interface 1300 is shown as displayed on a display screen 1302 of a display device. The user interface 1300 may be displayed in response to the worker selecting the ISM sub-task 1304 in the user interface 1100 or 1200 shown in FIG. 11 or in FIG. 12, respectively. A start timestamp may be captured when the worker selects the ISM sub-task (e.g., block 320 of FIG. 3A). Additionally, a progress indicator can be updated based on the selection of the ISM sub-task. Alternatively, in some embodiments, a start timestamp can be captured when the first sub-task is started and a stop timestamp captured when the last sub-task is completed (e.g., the amount of time needed to complete all of the sub-tasks).

The user interface 1300 may display information 1306 on the sub-task. For example, the information 1306 can include a number of elements associated with the sub-task (e.g., a number of ISM materials to be collected or 30 elements) and a total number of ISM materials to be collected (e.g., 34 items). The user interface 1300 can display a list 1308 of ISM materials to be collected. The list 1308 may include information 1310 for each ISM to be collected. The information 1310 may include a description 1312 of the ISM material, a quantity 1314 of the ISM material, and an identifier 1316 for the ISM material. In the illustrated embodiment, the identifier 1316 is a Department-Class-Item (DPCI) identifier, but the identifier may be different in other embodiments. For example, the identifier 1316 can be a universal product code (UPC). Example ISM materials include, but are not limited to, display platforms, signs, plastic sign holders, and plastic protective cases (e.g., a plastic protective case for non-functioning mobile phone).

Although not shown in FIG. 13, the user interface 1300 may include additional features. For example, the user interface 1300 can include input elements, such as the input elements 1228 shown in FIG. 12. Additionally or alternatively, the computing device (e.g., the system device 106 of FIG. 1) can adjust the number of ISM materials to be collected based on the types and numbers of ISM materials that are used in an existing planogram. In some embodiments, one or more images of some or all of ISM materials to be collected may be displayed in the user interface 1300 (e.g., see image areas 1716, 1804, 1906 of FIGS. 17-19).

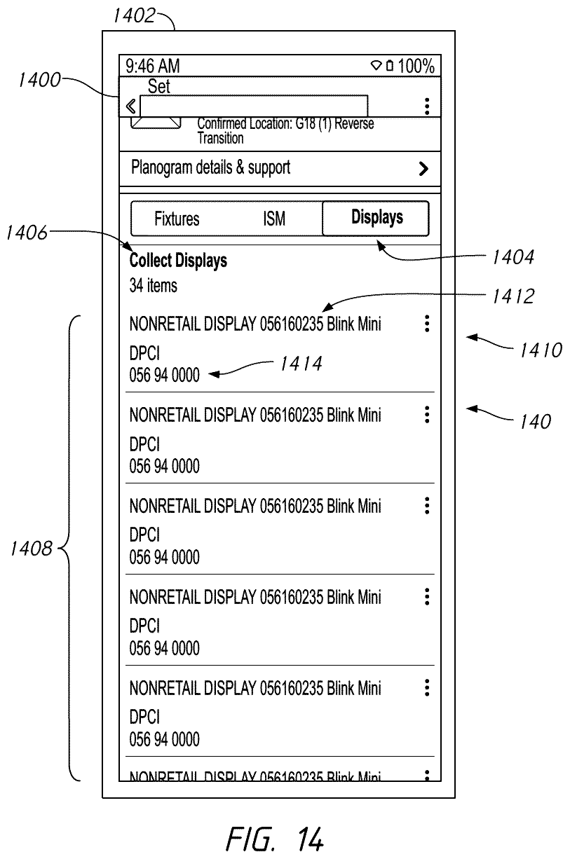

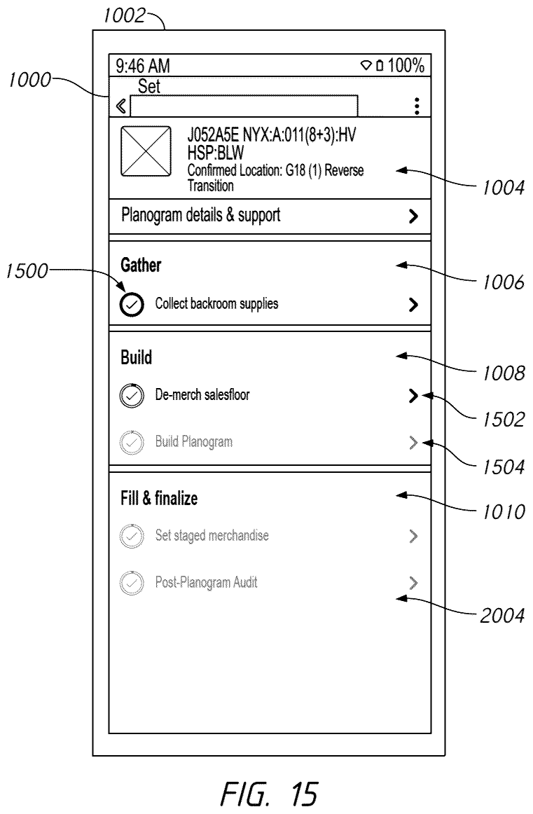

FIG. 14 illustrates an example user interface 1400 associated with a sub-task in a guided workflow according to an embodiment of the disclosure. The user interface 1400 is shown as displayed on a display screen 1402 of a display device. The user interface 1400 may be displayed in response to the worker selecting the Displays sub-task 1404 in the user interface 1100, 1200, or 1300 shown in FIG. 11, FIG. 12, and FIG. 13, respectively.

In one embodiment, a stop timestamp that is associated with the ISM sub-task may be captured in response to the section of the Displays sub-task 1404 (e.g., block 324 in FIG. 3B). A start timestamp that is associated with the Displays sub-task 1404 can be captured in response to the selection of the Displays sub-task 1404. Additionally or alternatively, one or more progress indicators may be updated based on the selection of the Displays sub-task 1404. Alternatively, as discussed earlier, a start timestamp can be captured when the first sub-task is started and a stop timestamp captured when the last sub-task is completed (e.g., the amount of time needed to complete all of the sub-tasks).

The user interface 1400 may display information 1406 on the sub-task. For example, the information 1306 can include a total number of display materials to be collected (e.g., 34 items). In one embodiment, the display materials include non-retail display items, such as non-functioning products.

The user interface 1400 can display a list 1408 of display items to be collected. The list 1408 may include information 1410 for each display item to be collected. The information 1410 may include a description 1412 of the display item and an identifier 1414 for the display item. In the illustrated embodiment, the identifier 1414 is a DPCI identifier, but other embodiments are not limited to this type of identifier.

Although not shown in FIG. 14, the user interface 1400 may include additional features. For example, the user interface 1400 can include input elements, such as the input elements 1228 shown in FIG. 12. Additionally or alternatively, a computing device (e.g., the system device 106 of FIG. 1) can adjust the number of display items to be collected based on the types and numbers of display items that are used in an existing planogram. In some embodiments, one or more images of the Displays to be collected may be displayed in the user interface 1400 (e.g., see image areas 1716, 1804, 1906 of FIGS. 17-19).

FIG. 15 illustrates the example user interface 1000 shown in FIG. 10 displaying the start screen after a phase is completed according to an embodiment of the disclosure. The user interface 1000 is shown as displayed on the display screen 1002 of a display device. In one embodiment, the user interface 1000 may be displayed in response to the completion of a phase. In FIG. 15, the gather phase 1006 has been completed. A progress indicator 1500 is displayed to indicate the completion of the gather phase 1006.

The worker is now ready to begin work on the next phase, the build phase 1008. The build phase 1008 includes two tasks; De-merch Salesfloor 1502 and Build Planogram 1504. The task of Build Planogram 1504 is shown as disabled (e.g., grayed out) in the illustrated embodiment because the tasks must be performed in order. Thus, the task of De-merch Salesfloor 1502 is performed before the task of Build Planogram 1504. Other embodiments are not limited to this implementation, and a worker may perform the tasks in any order.

FIG. 16 illustrates an example user interface 1600 for a task in a guided workflow according to an embodiment of the disclosure. The user interface 1600 is shown as displayed on a display screen 1602 of a display device. In one embodiment, the user interface 1600 may be displayed in response to the selection (e.g., tap) of the De-merch salesfloor task 1502 in the user interface 1500 shown in FIG. 15.

The user interface 1600 displays information 1604 on the planogram, including the location and a description of the planogram as well as information 1606 on the task. A list 1608 of actions to be performed are displayed based on a selection of the Actions tab 1610. Each action 1612, 1614, 1616 includes a description of the work to be performed. The user interface 1600 may also include an input element 1618 that when selected, causes a previous action to be displayed. Another input element 1620 causes a next section to be displayed when selected.

FIG. 17 illustrates an example user interface 1700 that displays information on a planogram in a guided workflow according to an embodiment of the disclosure. The user interface 1700 is shown as displayed on a display screen 1702 of a display device. In one embodiment, the user interface 1700 may be displayed in response to the selection (e.g., tap) of the input element 1620 shown in FIG. 16.

The user interface 1700 displays an image 1704 of a section of the merchandise display (e.g., Section #1) when completed along with a dimension 1706 of the section (e.g., a width of the section). The user interface 1700 displays labels 1708 (“F”, “M”, “A”) that are used to indicate the type of work to be performed in the area around or underlying the labels 1708. An image key 1710 provides descriptions of the work associated with the labels 1708.

One or more thumbnail images 1712 of the merchandise display can be displayed in the user interface 1700. The user interface 1700 is shown as displaying the thumbnail image 1704'. The worker may select (e.g., tap) another thumbnail image (e.g., the thumbnail image 1714′) to cause that thumbnail image to be displayed in the image area 1716 of the user interface 1700. In some embodiments, the thumbnail images 1712 are unique to a particular planogram. In another embodiment, the thumbnail images 1712 are unique to a type of planogram. The thumbnail images 1712 may be presented for some planograms and not other planograms.

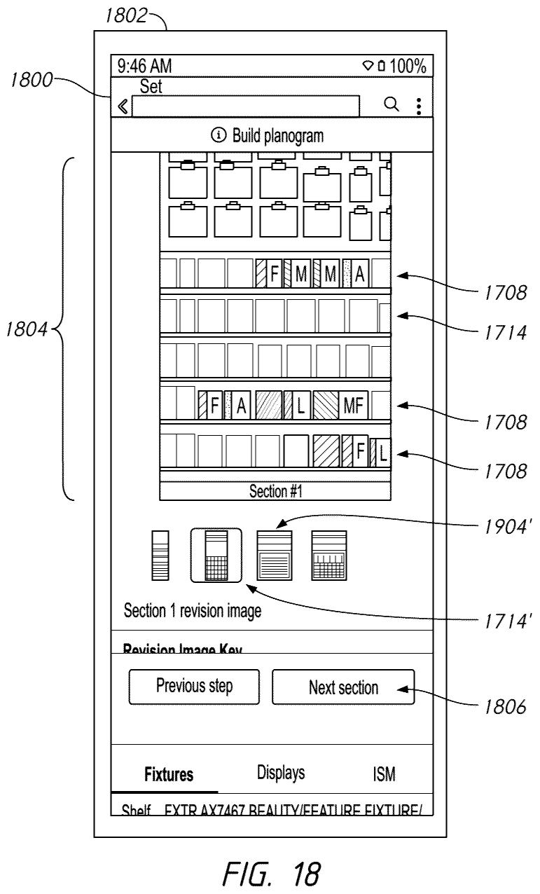

FIG. 18 illustrates an example user interface 1800 that displays information on a planogram in a guided workflow according to an embodiment of the disclosure. The user interface 1800 is shown as displayed on a display screen 1802 of a display device. In one embodiment, the user interface 1800 may be displayed in response to the selection (e.g., tap) of the thumbnail image 1714′ shown in FIG. 17. The thumbnail image 1714′ is displayed as image 1714 in the image area 1804 of the user interface 1800. The image 1714 is a black and white illustration of Section #1 of the merchandise display. The image 1714 includes display labels 1708.

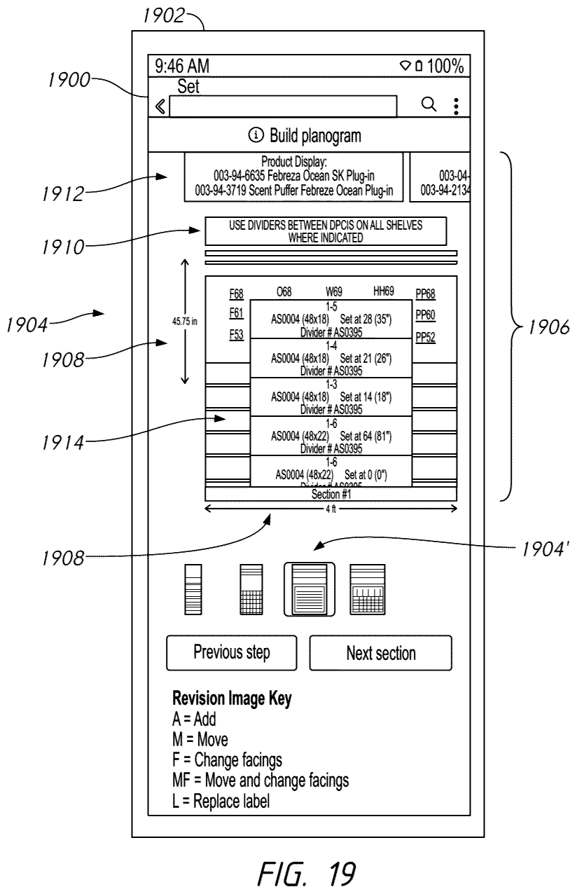

FIG. 19 illustrates an example user interface 1900 that displays information on a planogram in a guided workflow according to an embodiment of the disclosure. The user interface 1900 is shown as displayed on a display screen 1902 of a display device. In one embodiment, the user interface 1900 may be displayed in response to the selection (e.g., tap) of the thumbnail image 1904′ shown in FIG. 18.

The thumbnail image 1904′ is displayed as image 1904 in the image area 1906 of the user interface 1900. The image 1904 is a black and white illustration of Section #1 of the merchandise display. The image 1904 includes dimensions 1908 of associated with the merchandise display, information 1910 on the construction of the merchandise display (e.g., use of dividers), information 1912 on the product display, and information 1914 on the construction of the merchandise display (e.g., number, identifier and sizes of the dividers).

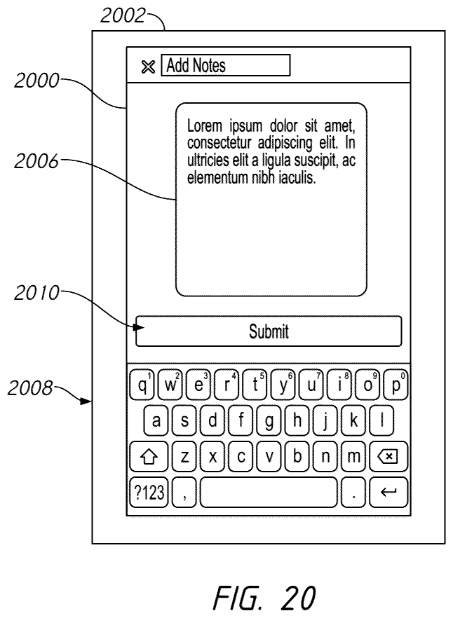

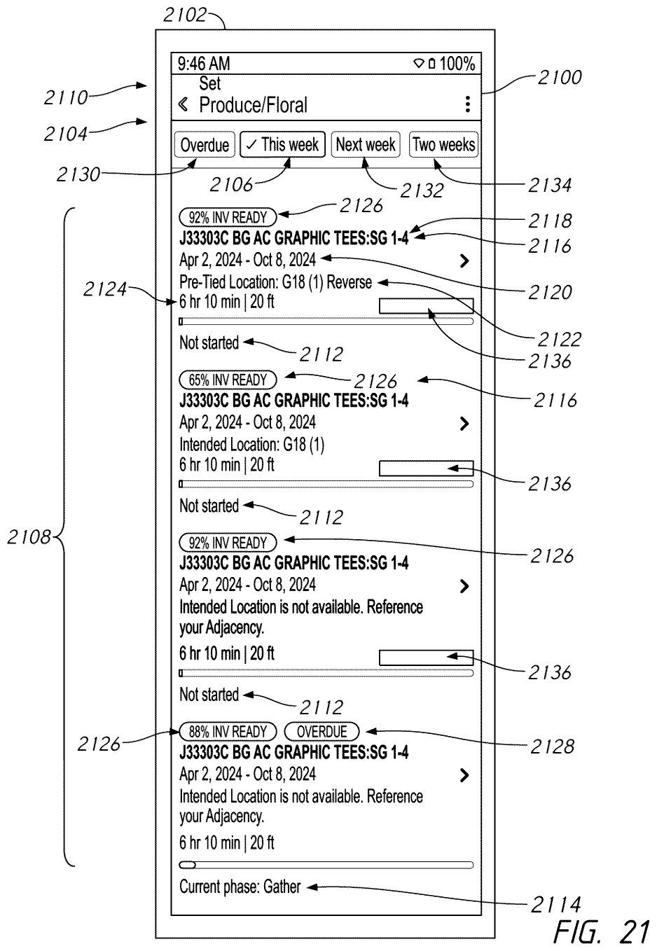

FIG. 20 illustrates an example user interface 2000 in a guided workflow according to an embodiment of the disclosure. The user interface 2000 is shown as displayed on a display screen 2002 of a display device. In one embodiment, the user interface 2000 may be displayed in response to the selection (e.g., tap) of the Post-Planogram Audit 2004 task shown in the Fill & Finalize phase of FIG. 10 and FIG. 15.

In some instances, the tasks that are listed above the Post-Planogram Audit task in the user interfaces shown in FIGS. 10 and 15 must be completed before the Post-Planogram Audit task can be selected. For example, in FIG. 15, the Fill and Finalize phase includes the tasks of “Set staged merchandise” and “Post-Planogram Audit.” The “Set staged merchandise” task may be required to be performed before the “Post-Planogram Audit” task. The task(s), action(s), and any sub-task(s) to be performed for the “Set staged merchandise” task may be displayed in a user interface (not shown) in response to the selection (e.g., tap) of the “Set staged merchandise” task. For example, as shown in FIG. 4, the “Set staged merchandise” task includes the sub-tasks of “Put away non-retail & ISM” and “Scan details.” The sub-tasks may be displayed in a user interface that is similar to the user interface 1100, 1200, 1300, 1400 shown in FIGS. 11-14, respectively. Additionally, the user interface may include images and/or other information that is associated with the sub-task. In other embodiments, tasks and/or sub-tasks may be performed in any order.

The tasks in the Fill and Finalize phase are performed at the end of, or after the construction of the merchandise display associated with the planogram. In one embodiment, the Post-Planogram Audit task can be used by the worker to provide notes on the construction of the merchandise display associated with the planogram. For example, the worker can describe a challenge or issue in the construction of the merchandise display and/or a suggestion for a different layout of the merchandise display associated with the planogram. The user interface 2000 includes an input element 2006, such as a text box, to enable the worker to input the notes. The text may be entered by the worker using the virtual keyboard 2008. The worker can select the input element 2010 to submit the notes to a computing device (e.g., the system device 106 shown in FIG. 1).

FIG. 21 illustrates an example user interface 2100 displaying information on multiple planograms according to an embodiment of the disclosure. The user interface 2100 is shown as displayed on a display screen 2102 of a display device. In one embodiment, the user interface 2100 may be displayed in response to a worker and/or a supervisor launching the guided workflow (e.g., via the software 112 shown in FIG. 1).

The user interface 2100 displays input elements 2104 (e.g., buttons) that can be selected to display a list of planograms. For example, in FIG. 21, the “this week” input element 2106 is selected and a list 2108 of planograms for the week are displayed. In some embodiments, the planograms are associated with a particular department, section or area of a retail business. For example, the planograms listed in the list 2108 are associated with the Produce/Floral department 2110 in the illustrated embodiment.

As shown in FIG. 21, the planograms in the list 2108 are associated with merchandise displays in which construction has not started or is in progress. Progress indicators are displayed to indicate the status of the planograms (e.g., “Not started” 2112 or “Current phase: gather” 2114). Information 2116 is displayed for each planogram. The information 2116 may include, but is not limited to, a description 2118 of the planogram, a date range 2120 that the merchandise display will be on the salesfloor, a location 2122, and a time estimate to construct the merchandise display and a size of the merchandise display 2124.

Progress indicators 2126 may also be displayed for each planogram in the list 2108. The progress indicators 2126 may indicate the status of the planogram, the status of the current phase for the planogram, or another status. In the illustrated embodiment, the progress indicators 2126 indicate a percentage of the inventory for the merchandise display that is associated with the planogram that is ready. In some instances, the progress indicators 2126 can be color coded to reflect a state of a schedule for the planogram. For example, a progress indicator 2126 may be colored green when the state of schedule for the planogram is good (or on schedule), yellow when the state of the schedule is at risk, and red when the state of the schedule is behind schedule. Alternatively, the progress indicators 2126 may be color coded to reflect the availability of the inventory (e.g., inventory levels) for the merchandise display. The progress indicators 2126 may be color coded differently and/or the color coding can have different meanings in other embodiments.

The user interface 2100 may also display another progress indicator 2128. In the illustrated embodiment, the progress indicator 2128 indicates the planogram is overdue. The worker and/or the supervisor may also view the overdue planograms by selecting (e.g., tap) the input element 2130. A list of planograms that are scheduled for the next week may be displayed in the user interface 2100 based on the selection of the input element 2132. Similarly, a list of planograms that are scheduled for two weeks out may be displayed in the user interface 2100 based on the selection of the input element 2134.

In some embodiments, a planogram may be assigned to one or more workers for execution (e.g., to work on) using the input element 2136 (e.g., a text box). For example, a supervisor may use the supervisor device 104 shown in FIG. 1 to assign planograms. Additionally or alternatively, a planogram can be assigned to one or more workers using a web-based application. Once assigned, the planogram(s) may be displayed in real-time on the worker device(s) associated with the worker(s) (e.g., worker device 102 of FIG. 1).

In some embodiments, during or after each phase, task, and/or sub-task the system (e.g., the system device 106 of FIG. 1) may prompt a worker to input notes on the phase, task, and/or sub-task. Additionally or alternatively, the worker can select an input element to input notes regarding the phase, task, and/or sub-task. The note may describe an issue encountered during the phase, task, and/or sub-task and the solution, a suggestion/recommendation for future merchandise displays, any substitutions, a location change, and the like. For example, a text box similar to the text box 704 shown in FIG. 7 can be presented to the worker in a respective UI. A request for notes may also be presented at the end of the construction of the merchandise display to again ask for any notes on any of the phases, tasks, and/or sub-tasks. For example, the text box 2006 shown in the UI of FIG. 20 may be presented to the worker (e.g., as part of the Post-Planogram Audit 2004 task).

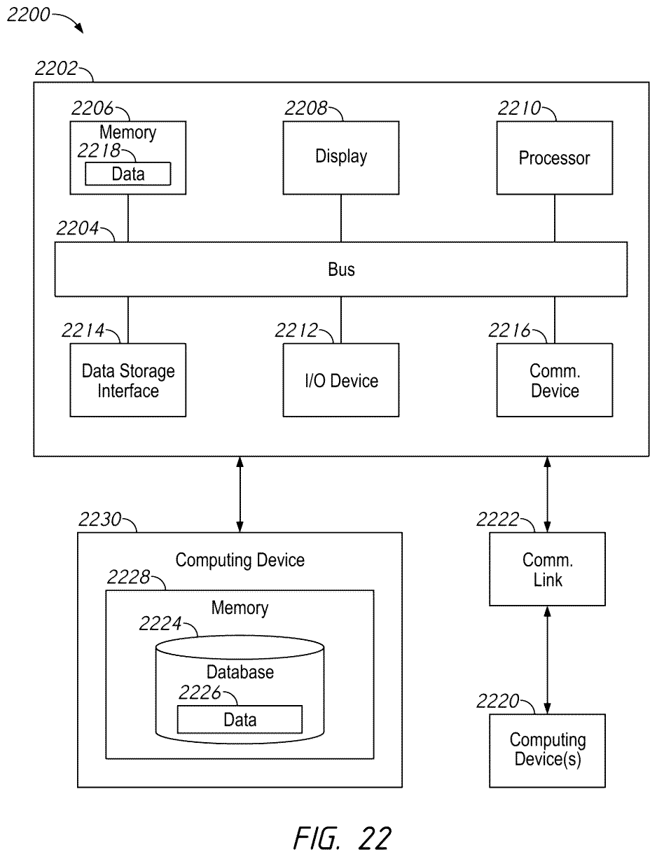

One advantage to receiving notes during or after each phase, task, and/or sub-task is the notes are received in the context of the UI for that phase, task, and/or sub-task that the worker is currently working on or just completed. The notes can be stored in a storage device (e.g., the memory 2206 and/or 2228 shown in FIG. 22) and included in one or more reports related to the construction of the merchandise display associated with a planogram (e.g., a report provided at block 340 of FIG. 3B). The notes can be used to improve the workflow of the planogram and/or the guided workflow. For example, a future planogram can be redesigned to avoid an issue a worker encountered in a past or current planogram. Additionally or alternatively, one or more UIs may be redesigned to modify a workflow (e.g., add or delete a phase, task, and/or sub-task and/or rearrange an order of phases, tasks, and/or sub-tasks).

Embodiments of the UIs disclosed herein show various input elements, including radio buttons (e.g., FIG. 12), links, buttons (e.g., FIG. 5 or FIG. 6), segmented buttons (e.g., FIG. 11), text boxes (e.g., FIG. 8), and right-facing carets (e.g., FIG. 10). However, different types of input elements may be used in other embodiments. Non-limiting nonexclusive examples of other input elements are dropdown menus, overflow menus, popup menus, toggle switches, checkboxes, and the like. Additionally or alternatively, the layouts of the UIs may differ in other embodiments.

The systems, methods, and user interfaces disclosed herein may be implemented using various computing systems. FIG. 22 illustrates a block diagram of an example computing system 2200 for implementing various embodiments in the examples described herein. For example, the worker devices 102, 104, the supervisor device 106, and the system device 106 shown in FIG. 1 may include or be implemented as the computing system 2200. This disclosure contemplates any suitable number of computing systems 2200. For example, the computing system 2200 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 2200 may include one or more computing systems; be unitary or distributed; span multiple locations; span multiple locations; span multiple machines; span multiple data centers; or reside in a cloud, which may include one or more cloud components in one or more networks.

The computing system 2200 includes a first computing device 2202 that includes one or more communication structures, such as a bus 2204 (e.g., an address bus and a data bus) or other communication mechanism for communicating information, which interconnects subsystems and devices, such as memory 2206, a display 2208, a processor 2210, an input/output (I/O) device 2212, a data storage interface 2214, and a communications device 2216. Although only one of each component is shown in FIG. 22, other embodiments can include one or more of the bus 2204, the memory 2206, the display 2208, the processor 2210, the input/output device 2212, the data storage interface 2214, and/or the communications device 2216.

The memory 2206 is configured to store information, such as data and software applications (collectively data 2218). In one embodiment, the data 2218 can include data associated with one or more planograms and/or user interfaces and processor-executable instructions for one or more software applications. The data 2218 can include different or additional data in other embodiments. The memory 2206 may be implemented as one or more types of volatile and non-volatile memory. For example, the memory 2206 can be a read only memory (ROM), dynamic and/or static random-access memory (RAM), flash memory, cache memory, erasable programmable ROM (EPROM), electrically erasable programmable ROM (EEPROM), virtual memory, optical memory, magnetic memory, and combinations thereof.

In particular embodiments, the processor 2210 includes hardware for executing processor-executable instructions, such as the instructions in a software application. The processor 2210 includes circuitry for performing various processing functions, such as executing specific software for perform specific calculations or tasks. For example, the processor 2210 may be implemented as a microprocessor, a central processing unit, a graphics processing unit, a neural processing unit, a digital signal processor, or combinations thereof.

The bus 2204 can include one or more memory buses (which may each include an address bus and a data bus) that couple the processor 2210 to the memory 2206. In particular embodiments, one or more memory management units (MMUs) reside between the processor 2210 and the memory 2206 and facilitate accesses to the memory 2206 as requested by the processor 2210. In particular embodiments, the bus 2204 includes hardware, software, or both coupling components of the computing device 2202 to each other.

The display 2208 includes circuitry and a display screen and is configured to present information on the display screen. The display screens 502, 602, 702, 802, 902, 1002, 1102, 1202, 1302, 1402, 1602, 1702, 1802, 1902, 2002, 2102 shown in FIGS. 5-21 may be presented on the display 2208. Alternatively, some of the display screens 502, 602, 702, 802, 902, 1002, 1102, 1202, 1302, 1402, 1602, 1702, 1802, 1902, 2002, 2102 shown in FIGS. 5-21 may be presented on the display 2208 and the remaining display screens on one or more other displays when a merchandise display is constructed by multiple workers. The display screens may be used to display the graphical user interfaces and associated data/information described herein.

In particular embodiments, the I/O device 2212 includes hardware, software, or both, providing one or more interfaces for communication between the I/O device 2212 and other components within the computing device 2202 and/or external to the computing device 2202. One or more of the I/O devices 2212 may enable communication between a user and the computing device 2202. The I/O device 2212 can include, but is not limited to, a keyboard, a keypad, a mouse, a microphone, speakers, input buttons, and combinations thereof. In some embodiments, the display 2208 may also function as an I/O device when the display 2208 is implemented as a touchscreen display that is configured to receive touch and/or force inputs as well as display information.

In particular embodiments, the communication device 2216 includes hardware, software, or both providing one or more interfaces for communication (such as, for example, packet-based communication) between the computing device 2202 and one or more other computing devices 2220. Example communications devices 2216 include, but are not limited to, a modem, an Ethernet card, a network interface controller (NIC) or network adapter for communicating with an Ethernet or other wire-based network, a wireless NIC (WNIC) or wireless adapter for communicating with a wireless network, such as a WI-FI network, and combinations thereof.

According to particular embodiments, the computing device 2202 performs specific operations by the processor 2210 executing one or more sequences of one or more processor-executable instructions stored in the memory 2206. For example, processor-executable instructions for one or more of the graphical user interfaces, for one or more software applications, and/or one or more of the methods and operations described herein may be stored in the memory 2206 and may be executed by the processor 2210. Such processor-executable instructions may be read into the memory 2206 from another computer readable/usable medium, such as removable computer readable/usable medium (e.g., memory sticks, external hard drives). In alternative embodiments, hard-wired circuitry may be used in place of or in combination with processor-executable instructions. Thus, particular embodiments are not limited to any specific combination of hardware circuitry and/or software. In various embodiments, the term “logic” means any combination of software or hardware that is used to implement all, or part of particular embodiments disclosed herein.

The term “computer readable medium” or “computer usable medium” as used herein refers to any medium that participates in providing instructions to processor 2210 for execution. Such a medium may take many forms, including but not limited to, nonvolatile media and volatile media.

The computing device 2202 may transmit and receive data and instructions, including software applications (or processor-executable instructions) through a communications link 2222 and the communications device 2216. Received processor-executable instructions may be executed by the processor 2210 as it is received, and/or stored in the memory 2206 for later execution. In various examples, the communications link 2222 may be configured as a network (e.g., the network 110 of FIG. 1) to enable the computing device 2202 to communicate with, for example, worker devices, supervisor devices, and system devices (e.g., the worker devices 102, 104, the supervisor device 106, and the system device 106 of FIG. 1).

The computing system 2200 may further include one or more databases (database 2224) that may be used to store data and/or software applications (collectively data 2226). In one embodiment, the data 2226 can include data associated with one or more planograms and/or user interfaces and processor-executable instructions for one or more software applications. The data 2226 can include different or additional data in other embodiments.

The database 2224 can be accessed by the computing device 2202 by way of the data storage interface 2214 and/or the communications device 2216. The database 2224 can be stored in a memory 2228 that is included in another computing device 2230. The memory 2228 may be implemented similar to the memory 2206, and the computing device 2230 can be implemented as the computing device 2202. As such, the memory 2228 and the computing device 2230 are not described in detail.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium (e.g., computer-readable medium) readable by a computer system and encoding a computer program. It should further be understood that the described technology may be employed in special purpose devices independent of a personal computer.

The above specification, examples and data provide a complete description of the structure and use of exemplary embodiments of as defined in the claims. Although various embodiments have been described above with a certain degree of particularity, or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements as defined in the following claims.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A computer-implemented method for executing a planogram, the method comprising:
transmitting, to a computing device, a first user interface configured to present a selectable task associated with the planogram and a selectable input element to be selected when the task is completed;
receiving, from the computing device, a selection of the task;
receiving a start timestamp in response to receiving the selection of the task;
responsive to receiving the selection of the task, transmitting, to the computing device, a second user interface configured to present information associated with the task and a selectable input element to be selected when the task is completed, the information comprising a list of one or more actions to be performed;
receiving, from the computing device, a selection of the selectable input element indicating the task is completed; and
receiving a stop timestamp in response to receiving the selection of the selectable input element;
based on the start and the stop timestamps, determining an amount of time needed to complete the task; and
transmitting, to the computing device or to another computing device, a notification indicating the task is completed and the amount of time needed to complete the task.

2. The computer-implemented method of claim 1, further comprising transmitting, to the computing device, a third user interface configured to display items to be used in a merchandise display associated with the planogram to enable the items to be collected and grouped together in storage.

3. The computer-implemented method of claim 2, further comprising transmitting, to the computing device, a notification indicating receipt of the items to be used in the merchandise display.

4. The computer-implemented method of claim 1, further comprising:
receiving, from the computing device, a confirmation of a location for a merchandise display to be constructed, the merchandise display associated with the planogram; or
receiving, from the computing device, a user input indicating a new location for the merchandise display to be constructed.

5. The computer-implemented method of claim 1, further comprising:
after receiving the selection of the task, transmitting, to the computing device, a third user interface configured to present a sub-task associated with the task, the third user interface configured to present a progress indicator for the sub-task;
responsive to receiving a selection of the sub-task, transmitting, to the computing device, a fourth user interface configured to present information associated with the sub-task and a selectable input element to be selected when the sub-task is completed; and
receiving, from the computing device, a selection of the selectable input element indicating the sub-task is complete.

6. The computer-implemented method of claim 5, wherein the information further comprises a description of the sub-task.

7. The computer-implemented method of claim 5, wherein the information further comprises dimensions of at least a portion of a merchandise display associated with the planogram.

8. The computer-implemented method of claim 5, wherein the information further comprises an image presenting at least a portion of a merchandise display that is associated with the planogram.

9. A system, comprising:
a processor; and
a memory storing instructions, that when executed by the processor, cause operations to be performed, the operations comprising:
transmitting, to a computing device, a first user interface configured to present a plurality of selectable tasks associated with a new merchandise display to be constructed and first selectable input elements to be selected when each task is completed, wherein the plurality of selectable tasks is included in a planogram;
for each task in the list of selectable tasks:
receiving a selection of a task;
receiving a start timestamp in response to receiving the selection of the task;
after receiving the selection of the task, transmitting, to the computing device, a second user interface configured to present a sub-task associated with the task, wherein the sub-task is included in the planogram;
responsive to receiving a selection of the sub-task, transmitting, to the computing device, a third user interface configured to present information associated with the sub-task and a second selectable input element to be selected when the sub-task is completed;
receiving, from the computing device, a selection of the second selectable input element indicating the sub-task is completed;
receiving, from the computing device, a selection of the first selectable input element indicating the task is completed;
receiving a stop timestamp in response to receiving the selection of the first selectable input element;
based on the start and the stop timestamps, determining an amount of time needed to complete the task; and
transmitting, to the computing device, a notification indicating the plurality of tasks is completed and the amount of time needed to complete each task.

10. The system of claim 9, wherein:
the information associated with the sub-task is a list of items to be collected;
the list of items includes a quantity of each item to be used in the new merchandise display; and
the memory stores further instructions for:
determining a quantity of each item used in an existing merchandise display at a location where the new merchandise display is to be constructed; and
adjusting the quantity of at least one item to be used in the new merchandise display based on the quantity of the at least one item used in the existing merchandise display.

11. The system of claim 9, wherein the planogram is divided into a plurality of phases, and the plurality of tasks are associated with a phase in the plurality of phases.

12. The system of claim 11, wherein the memory stores further instructions for transmitting, to the computing device, a fourth user interface displaying a list of the plurality of phases and a progress indicator associated with each phase.

13. The system of claim 12, wherein the memory stores further instructions for updating the progress indicator associated with a respective phase in response to receiving for each task, the selection of the selectable input element indicating the task is completed.

14. The system of claim 13, wherein:
the notification is a first notification; and
the memory stores further instructions for transmitting, to the computing device or another computing device, a second notification indicating construction of the new merchandise display is completed in response to completing the plurality of phases.

15. The system of claim 11, wherein:
the start timestamp is a first start timestamp;
the stop timestamp is a first stop timestamp; and
the memory stores further instructions for:
receiving a second start timestamp at a start of a first phase in the plurality of phases;
receiving a second stop timestamp at an end of a last phase in the plurality of phases; and
determining an amount of time needed to complete the construction of the new merchandise display based on the second start timestamp and the second stop timestamp.

16. A computer-implemented method of executing a guided workflow to construct a merchandise display associated with a planogram, the method comprising:
transmitting, to a first computing device, a first user interface configured to present a selectable task associated with the merchandise display and a progress indicator for the selectable task;
responsive to receiving a selection of the task, transmitting, to the first computing device, a second user interface configured to present a plurality of sub-tasks associated with the task;
receiving a start timestamp based on receiving the selection of the task;
for each sub-task in the plurality of sub-tasks:
responsive to receiving a selection of a sub-task, transmitting, to the first computing device, a third user interface configured to present information associated with the sub-task and a selectable input element to be selected when the sub-task is completed;
receiving, from the first computing device, a selection of the selectable input element indicating the sub-task is completed;
updating the progress indicator associated with the task based on the completion of the sub-task;
receiving a stop timestamp based on completion of the plurality of sub-tasks;
based on the start and the stop timestamps, determining an amount of time needed to complete the task; and
transmitting, to a second computing device, a notification indicating the task is completed and the amount of time needed to complete the task.

17. The computer-implemented method of claim 16, wherein:
the planogram is included in a plurality of planograms; and
the method further comprising transmitting, to the second computing device, a fourth user interface displaying the plurality of planograms and a progress indicator for each planogram in the plurality of planograms.

18. The computer-implemented method of claim 16, further comprising:
receiving, from the first computing device, a user input indicating a new location for the merchandise display to be constructed; and
receiving, from the first computing device, a user input indicating a reason for the new location.

19. The computer-implemented method of claim 18, wherein:
a sub-task in the plurality of sub-tasks is performed after the merchandise display is constructed; and
the method further comprises:
receiving, from the first computing device, feedback associated with the construction of the merchandise display; and
transmitting, to the second computing device, a report on the construction of the merchandise display, the report including the reason for the new location and the feedback.

20. The computer-implemented method of claim 16, wherein:
the information associated with at least one sub-task is a list of items to be collected;
the list of items includes a quantity of each item to be used in the merchandise display; and
the method further comprises:
determining a quantity of each item used in an existing merchandise display at a location where the merchandise display is to be constructed; and
adjusting the quantity of at least one item to be used in the merchandise display based on the quantity of the at least one item used in the existing merchandise display.
